(19) United States
(12) Patent Application Publication
(10) Pub. No.: US 2012/0015656 A1
(43) Pub. Date: Jan. 19, 2012

(54) Method of Handling Multicall Functionality and Related Communication Device

(76) Inventor: Kundan Tiwari, Taoyuan County (TW)

(21) Appl. No.: 12/980,339

(22) Filed: Dec. 29, 2010

Related U.S. Application Data
(60) Provisional application No. 61/290,891, filed on Dec. 30, 2009.

(51) Int. Cl. H04W 36/00

(52) U.S. Cl. 455/436

(57) ABSTRACT

A method for handling multicall functionality for a wireless communication system is disclosed. The method includes sending an information element (IE) from a first core network node to a second core network node through a first message, wherein the IE contains multicall capability of the first core network node connected to a first network; forwarding the IE from the second core network node to a second network through a second message, the second network connected to the second core network node; and forwarding the IE from the second network to a mobile device through a handover procedure.

### CROSS REFERENCE TO RELATED APPLICATIONS

This application claims the benefit of U.S. Provisional Application No. 61/290,891, filed on Dec. 30, 2009 and entitled “Method to handle multicall functionality at UE supporting multicall feature after SRVCC handover from PS to CS”, the contents of which are incorporated herein.

### BACKGROUND OF THE INVENTION

1. Field of the Invention

The application relates to a method used in a wireless communication system and related communication device, and more particularly, to a method for handling multicall functionality in a wireless communication system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, an evolved universal terrestrial radio access network (E-UTRAN) includes a plurality of evolved Node-Bs (eNBs) and communicates with a plurality of mobile stations, also referred as user equipments (UEs).

A multicall service is a service that provides multiple independent CS active connections simultaneously in the mobile station. Multiple CS (Circuit Switched) connections and multiple PS (Packet Switched) connections can exist in the mobile station simultaneously and independently. The combination of Multicall is totally free and it is operator dependent and UE dependent.

A Single Radio Voice Call Continuity (SRVCC) provides the ability to transition a voice call from the VoIP/IMS (IP Multimedia Subsystem) packet domain to the legacy circuit domain. Variations of SRVCC are being standardized to support both GSM/UMTS and CDMA 1× circuit domains. For an operator with a legacy cellular network who wishes to deploy IMS/VoIP-based voice services in conjunction with the rollout of an LTE network, SRVCC offers provides their VoIP subscribers with coverage over a much larger area than would typically be available during the rollout of a new network.

SRVCC functions as follows. As an SRVCC-capable mobile station engaged in a PS voice call determines that it is moving away from LTE coverage, it notifies the LTE network. The LTE network determines that the PS voice call needs to be moved to the legacy circuit domain. It notifies a mobile switching center (MSC) server of the need to switch the voice call from the packet to the circuit domain and initiates a handover of the LTE voice bearer to the circuit network. The MSC server establishes a bearer path for the mobile station in the legacy network and notifies the IMS core that the mobile station's call leg is moving from the packet to the circuit domain. The circuit-packet function in the IMS core then performs the necessary inter-working functions. When the mobile station arrives on-channel in the legacy network, it switches its internal voice processing from VoIP to legacy-circuit voice, and the call continues.

The mobile station supporting multicall needs multicall supported information of network to know if the network supports mulitcall or not. This information is contained in a network call control capabilities information element (IE) of a CALL PROCEEDINGS message and a mobile terminated SETUP message. The network call control capabilities IE is sent only during first call setup procedure and this information is applicable till all CS call is released.

During SRVCC handover Procedure, the network call control capabilities IE is not included in messages involved in SRVCC handover. Therefore UE is not aware about the network multicall support capability and hence doesn't know if network supports multicall or not. The mobile station supporting multicall can't take decision to initiate multicall after SRVCC HO even though network supports multicall.

In addition, the mobile station supporting multicall initiates multicall by setting a stream identifier to the network not supporting multicall as described in TS 24.008 subclause 5.2.1 for mobile originating (MO) call and subclause 5.2.2.3 for mobile terminating (MT) call, then network can't handle SETUP messages for the MO call or CALL CONFIRMED messages.

### SUMMARY OF THE INVENTION

A method of handling multicall functionality for a wireless communication system and related communication device are provided.

A method for handling multicall functionality for a wireless communication system is disclosed. The method comprises sending an information element (IE) from a first core network node to a second core network node through a first message, wherein the IE contains multicall capability of the first core network node connected to a first network; forwarding the IE from the second core network node to a second network through a second message, the second network connected to the second core network node; and forwarding the IE from the second network to a mobile device through a handover procedure.

A method of handling multicall functionality for mobile device in a wireless communication system is disclosed. The method comprises receiving an information element (IE) from a first network through a handover procedure, wherein the IE contains multicall capability of a core network; and initiating the multicall functionality according to the IE when handing over to the second network.

A wireless communication system is disclosed. The wireless communication system comprises a first network, a first core network node, a second core network node and a second network. The first core network node is connected to the first network and used for sending an information element (IE) in a first message, wherein the IE contains multicall capability of the first core network node. The second core network node is used for receiving the IE from the first core network code and forwarding the IE in a second message. The second network is connected to the second core network and used for receiving the IE from the second core network node and forwarding the IE to a mobile device through a handover procedure.

A communication device of handling multicall functionality in a wireless communication system is disclosed. The communication device comprises means for receiving an information element (IE) from a first network through a handover procedure, wherein the IE contains multicall capability of a core network; and means for initiating the multicall functionality according to the IE when handing over to the second network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary wireless communication system.

FIG. 2 is a schematic diagram of an exemplary communication device.

FIG. 3 is a flow chart of an exemplary process.

FIG. 4 is an exemplary sequence diagram of a SRVCC handover procedure.

FIG. 5 is an exemplary sequence diagram of a SRVCC handover procedure.

FIG. 6 is a flow chart of an exemplary process.

### DETAILED DESCRIPTION

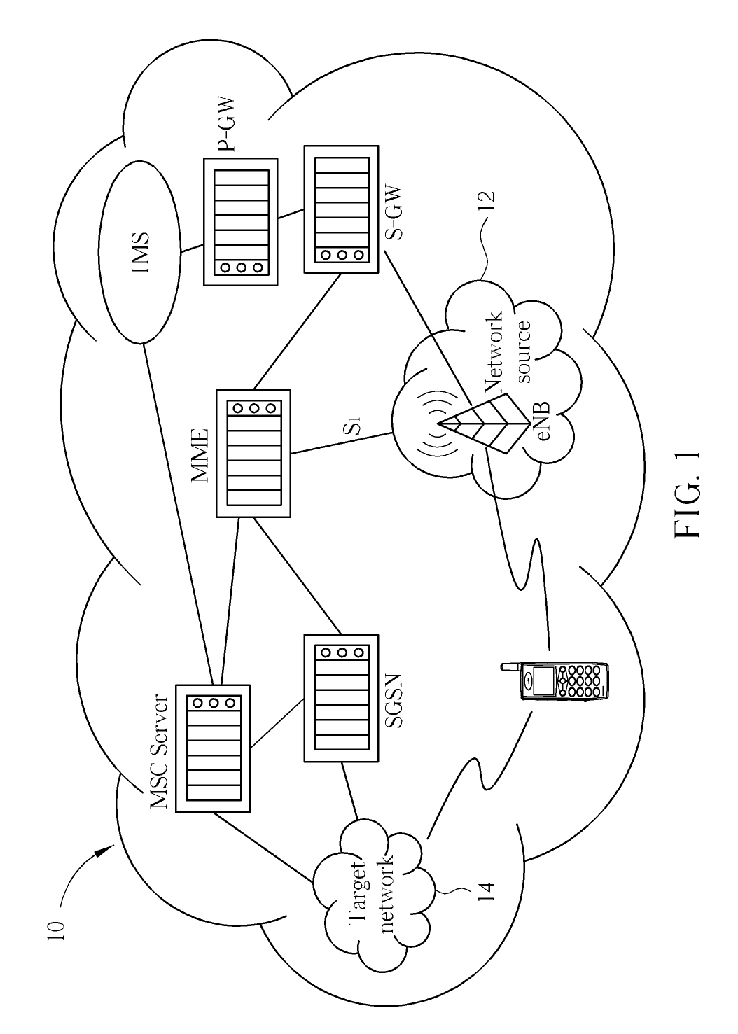

Please refer to FIG. 1, which illustrates a schematic diagram of an exemplary wireless communication system 10. In FIG. 1, a source network 12 serving a mobile device and a target network 14 employ different radio access technologies (RATs), and the mobile device supports both of the RATs. The source network 12 supports a single service domain and may be a LTE (long-term evolution) or a HSPA+ (High Speed Packet Access Plus) system network only supporting a PS (Packet Switched) service domain such as IP Multimedia Subsystem (IMS). The source network 12 is connected to core network nodes such as a serving gateway (S-GW) and a mobility management entity (MME). The MME serves as a local mobility anchor for inter-working with other RATs (e.g. GSM and UMTS). The S-GW and the source network 12 are both connected the MME, which is a control node processing signaling between the UE and a core network and also provides the control plane function for mobility between the LTE and 2G/3G access networks with the S3 interface terminating at the MME from a Serving GPRS Support Node (SGSN). The PDN GW (P-GW) is the gateway which terminates the SGI interface towards the PDN (IMS domain).

Functions of P-GW include for both the GTP-based and the PMIP-based S5/S8 e.g. the P-GW is responsible for IP address allocation for the UE. The target network 14 is connected to core networks nodes such as mobile switching center (MSC) and the SGSN. The MSC sever provides circuit-switched (CS) calling, mobility management, and GSM services to the mobile devices roaming within the area that it serves. The SGSN is responsible for the delivery of data packets to the mobile devices back and forth within its geographical service area, including packet routing and transfer, mobility management (attach/detach and location management), logical link management, and authentication and charging functions. The target network 14 supports multiple service domains and may be a network of a UMTS (Universal Mobile Telecommunications System) system, a GSM system or a GERAN Iu mode system supporting both PS (Packet Switched) and CS (Circuit Switched) service domains. In the LTE system, the network is referred as a EUTRAN (evolved-UTRAN) comprising a plurality of eNBs (evolved-Node Bs); In the UMTS system, the network is referred as a UTRAN (UTRAN) comprising a radio network controller (RNC) and a plurality of NBs (Node Bs); In the GSM/GERAN Iu mode system, the network is referred as a GERAN comprising a base station controller (BSC) and a plurality of base stations. The mobile device are referred as a user equipment (UEs) or a mobile station (MS) supporting the abovementioned RATs and may be a device such as a mobile phone, a computer system, etc. Besides, the networks and the mobile device can be seen as a transmitter or receiver according to transmission direction, e.g., for uplink (UL), the mobile device is the transmitter and the network is the receiver, and for downlink (DL), the network is the transmitter and the mobile device is the receiver. When the mobile device performs an inter-RAT handover from the source network 12 to the target network 14, the source network 12 transfers necessary configuration (capability, mobility, security configuration, etc.) of the target network 14 to the mobile device so that the mobile device communicates to the target network based on the transferred configuration and establishes a connection to the target network 14. When the connection establishment is successful, the mobile device disconnects with the source network 12.

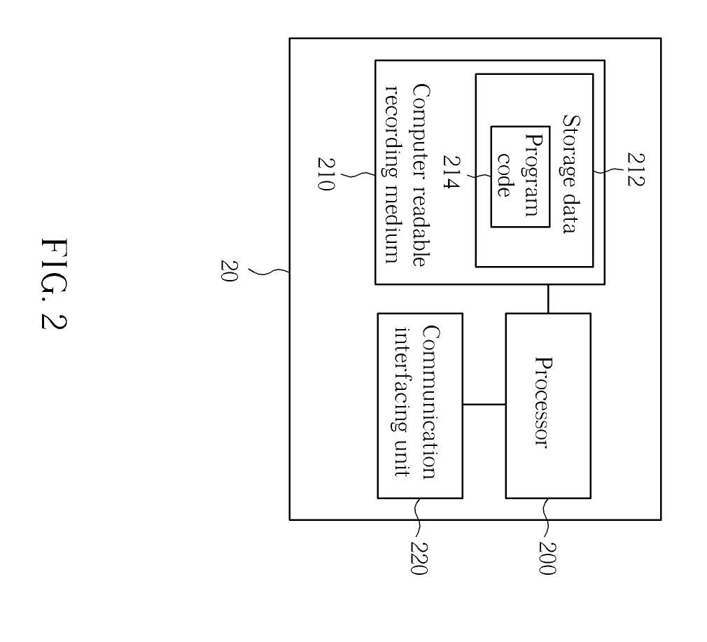

Please refer to FIG. 2, which is a schematic diagram of an exemplary communication device 20. The communication device 20 can be the mobile device or the network shown in FIG. 1 and includes a processor 200, a computer readable recording medium 210 and a communication interfacing unit 220. The computer readable recording medium 210 may be any data storage device that stores storage data 212, including program code 214, thereafter read and processed by the processor 200. Examples of the computer readable recording medium 210 include a subscriber identity module (SIM), read-only memory (ROM), random-access memory (RAM), CD-ROMs, magnetic tapes, hard disks, optical data storage devices, and carrier waves (such as data transmission through the Internet). The communication interfacing unit 220 is preferably a radio transceiver for wirelessly communicating with other communication devices and can transform process results from the processor 200 into radio signals.

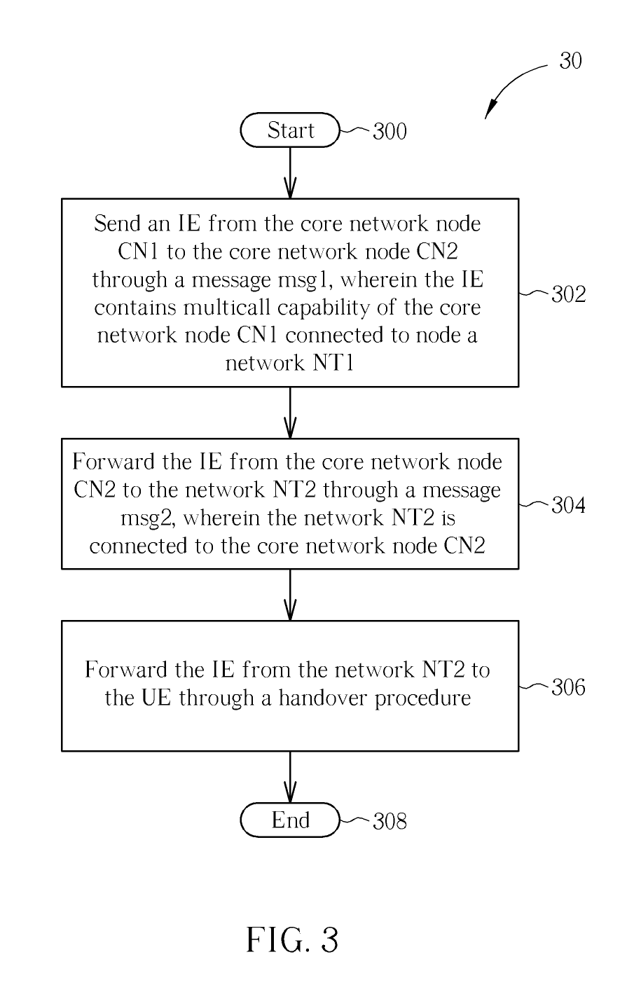

Please refer to FIG. 3, which is a flow chart of an exemplary process 30. The process 30 is used for handling multicall functionality for a wireless communication system. The wireless communication system could be the wireless communication system 10 and include a core network node CN1, a core network node CN2, a network NT1, a network NT2 and an UE. The process 30 can be compiled into the program code 214 and include the following steps:

Step 300: Start.

Step 302: Send an information element (IE) from the core network node CN1 to the core network node CN2 through a message msg1, wherein the IE contains multicall capability of the network node CN1 connected to a network NT1.

Step 304: Forward the IE from the core network node CN2 to the network NT2 through a message msg2, wherein the network NT2 is connected to the core network node CN2.

Step 306: Forward the IE from the network NT2 to the UE through a handover procedure.

Step 308: End.

According to the process 30, the core network node CN1 sends the IE to the core network node CN2 through the message msg1. Preferably, the IE is a network call control multicall capability IE, which contains multicall capability of the core network node CN1 (e.g. MSC server multicall capabilities). After receiving the message msg1, the core network node CN2 forwards the IE to the network NT2 through the message msg2. Then, the network NT2 forwards the IE to the UE through the handover procedure (i.e. the IE is sent in a handover command message from the network NT2 to the UE). Preferably, the handover procedure is referred as to a single radio voice call continuity (SRVCC) handover procedure. Therefore, after the SRVCC handover procedure, the IE containing the MSC server multicall capability of the core network node CN1 is passed to the UE. In the other words, the UE may know if the network NT1 supports the mutlicall functionality by performing the aforementioned process 30.

In some example, the network NT1 may be referred as to Universal Mobile Telecommunications System (UMTS) Terrestrial Radio Access Network (UTRAN) or GSM EDGE Radio Access Network (GREAN); the network NT2 may be referred as to Evolved UMTS Terrestrial Radio Access Network (E-UTRAN). In this situation, the core network node CN1 is a target mobile switching center (MSC) server, connected to the UTRAN or GREAN. The core network node CN2 is a source mobility management entity (MME), connected to the E-UTRAN. The message msg1 is a packet switch (PS) to circuit switch (CS) response message. The message msg2 is a handover command message. In other words, the target MSC server will send the network call control capabilities IE containing MSC server multicall capabilities to the source MME in the PS to CS Response message. The source MME then forwards the network call control capabilities IE to the source E-UTRAN in the handover command message. The E-UTRAN in turn forwards the network call control capabilities IE to the UE in a handover from E-UTRAN command message. Hence the UE obtains multicall capabilities of the target MSC during the SRVCC handover procedure.

On the other hand, if the SRVCC handover involves an inter MSC handover two more steps may be included in the process 30. For example, a source MSC may sends an indicator to a target MSC through a message msg3. The indicator is used for indicating to the target MSC that the handover procedure is a SRVCC handover procedure. The message msg3 may be referred as to a Prep handover request message. Then, the target MSC may send the IE to the core network node CN1 through a message msg4 according to the indicator. The message msg4 may be referred as to a Prep handover CS response message. That is, the source MSC indicates to the target MSC that the handover is a SRVCC handover by sending the indicator in Prep handover request message. If the target MSC finds the indicator present in the Prep handover request message then the target MSC sends the network call control capabilities IE containing multicall capabilities of the network NT1 to the core network node CN1 (e.g. target MSC server) in the Prep handover CS Response message. The core network node CN1 (e.g. target MSC server) forwards the IE to the core network node CN2 (e.g. source MME) in the PS to CS Response message. The following operations can be found above and thus omitted herein.

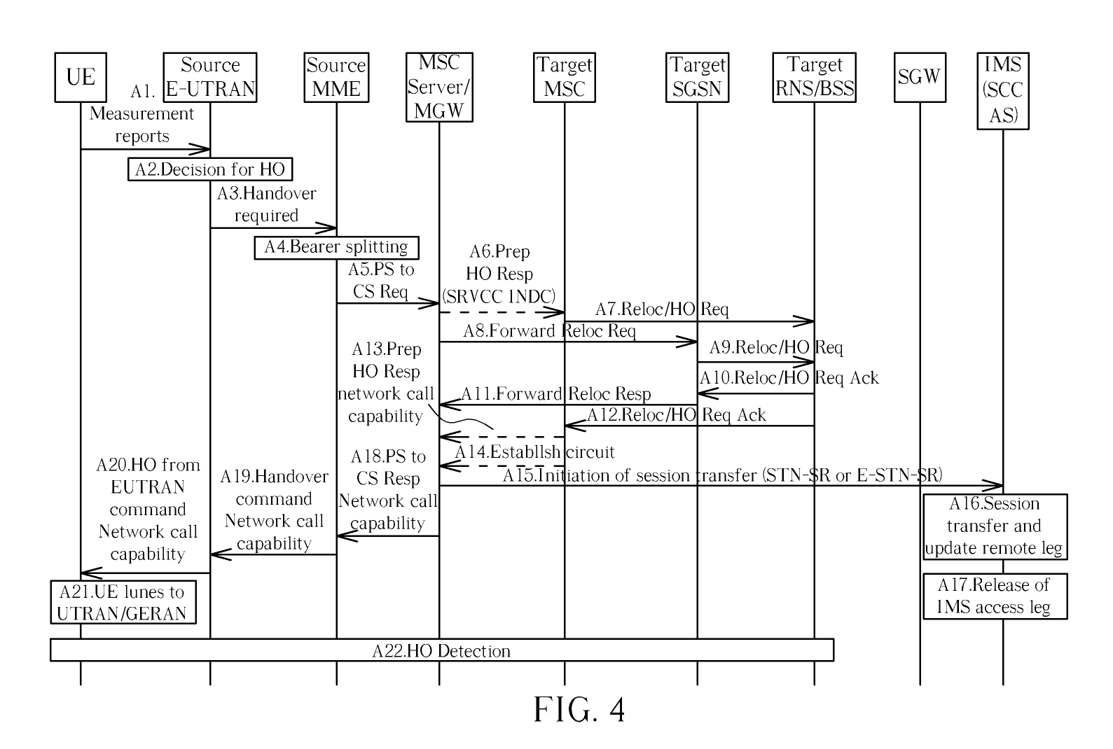

Please refer to FIG. 4, which is an exemplary sequence diagram 40 of a SRVCC handover procedure based on the concept of the process 30. The SRVCC handover is from the E-UTRAN to the UTRAN or GERAN system with DTM (Data Transfer Mode) handover support. A source E-UTRAN is a source network, and a target BSS (Base Station Subsystem) is a target network (e.g. UTRAN or GERAN). The source MME is a core network node of the LTE system, and a target MSC and a target SGSN is core network nodes of the GSM system. A MSC server/Media gateway (MGW) is an interfacing core network node between the LTE and GSM systems. An IMS Session Continuity Control Application Server (SCC AS) is used for handover between CS and IMS. The SRVCC handover with DTM support includes the following steps:

A1: The UE sends a measurement report to the source E-UTRAN.

A2: The source E-UTRAN decides to trigger the SRVCC handover to the GERAN/UTRAN based on UE measurement reports.

A3: The source E-UTRAN sends a “Handover Required” message to the source MME.

A4: The source MME splits the voice bearer from non-voice bearers.

A5: The source MME sends a PS to CS Request to MSC Server, initiating a PS-CS handover procedure for the voice bearer.

A6: The MSC server sends a SRVCC indicator to the target MSC in a Prep handover request, the SRVCC indicator indicating the handover is the SRVCC handover.

A7: The target MSC requests resource from the target BSS by Relocation/Handover request.

A8: In parallel, the source MME requests the relocation of PS resources from the target SGSN for the non-voice bearers.

A9: The target SGSN in turn requests resources from the target BSS by Relocation/Handover request.

A10: The target BSS sends response by a Relocation/Handover Request acknowledgement.

A11: The target BSS forwards the response to the source MME.

A12: The target BSS sends a Relocation/Handover Request acknowledgement back to the target MSC.

A13: The target MSC sends network call control capabilities IE in a Prep Handover CS Response message.

A14: After having received the response from the target BSS, the message are exchanged to establish traffic circuit.

A15: The MSC server initiates session transfer by sending ISUP IAM message using session transfer number for SRVCC (STN-SR) or Emergency Session Transfer Number for SRVCC (E-STB-SR).

A16: The IMS SCC Application Server continues the handling by transferring the session, updating the remote leg.

A17: The IMS SCC Application Server releasing the IMS (source) leg via E-UTRAN. From this point onwards the downlink IP (for voice) packets flow via the IMS/CS interconnecting node and are transformed to CS data streams.

A18: The MSC server sends the response for PS to CS handover to the source MME, including the network call control capabilities IE.

A19: The source MME forwards the network call control capabilities IE to the source E-UTRAN in a Handover command message.

A20: The source E-UTRAN forwards the network call control capabilities IE to the UE in a Handover From E-UTRAN command message.

A21: The UE tunes to a frequency spectrum of the UTRAN/GERAN system.

A22: The UE performs handover detection at the target BSS.

In another example, the network NT1 may be referred as to a target UTRAN or GREAN; the network NT2 may be referred as to a source UTRAN (e.g. High Speed Downlink Packet Access (HSDPA)). In this situation, the core network node CN1 is a target MSC server, connected to the target UTRAN or GREAN. The core network node CN2 is a source Serving GPRS Support Node (SGSN), connected to the source UTRAN. The message msg1 is a PS to CS response message. The message msg2 is a Relocation Required command. In other words, the target MSC server will send the network call control capabilities IE containing MSC server multicall capabilities to the source SGSN in the PS to CS Response message. The source SGSN then forwards the network call control capabilities IE to the source UTRAN in the Relocation Required command. The source UTRAN in turn forwards the network call control capabilities IE to the UE in a handover from UTRAN command message. Hence the UE obtains multicall capabilities of the target MSC during the SRVCC handover procedure.

If the SRVCC handover involves an inter MSC handover two more steps may be included in the process 30. For example, a source MSC may sends an indicator to a target MSC through the message msg3. The indicator is used for indicating the handover procedure is a SRVCC handover procedure. The message msg3 may be referred as to a Prep handover request message. Then, the target MSC may send the IE to the core network node CN1 through the message msg4 according to the indicator. The message msg4 may be referred as to the Prep handover CS response message. That is, the source MSC indicates to the target MSC that the handover is a SRVCC HO by sending the indicator in Prep handover request message. If the target MSC finds the indicator present in the Prep handover request message then the target MSC sends the network call control capabilities IE containing multicall capabilities of the network NT1 to the core network node CN1 (e.g. target MSC server) in the Prep handover CS Response message. The core network node CN1 (e.g. target MSC server) forwards the IE to the core network node CN2 (e.g. source SGSN) in the PS to CS Response message. The following operations can be found above and thus omitted herein.

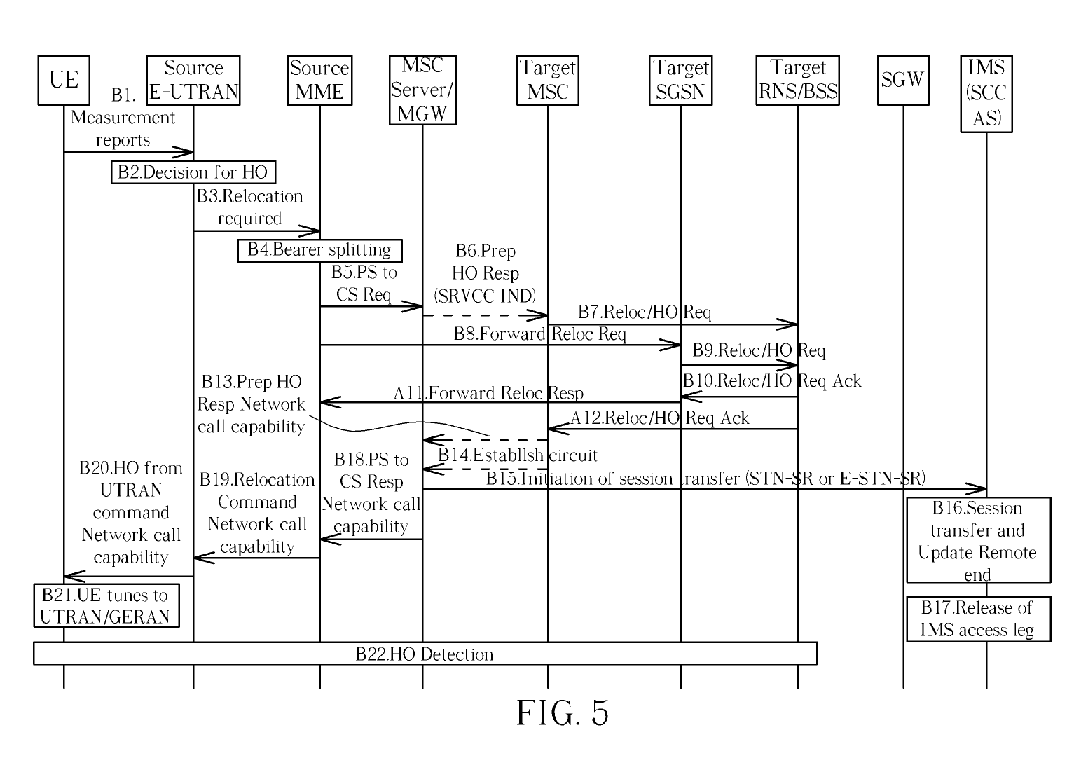

Please refer to FIG. 5, which is an exemplary sequence diagram 50 of a SRVCC handover procedure based on the concept of the process 30. The SRVCC handover is from a source UTRAN (HSPA) to a target UTRAN or GERAN system with DTM (Data Transfer Mode) handover support. A source UTRAN is a source network, and a target BSS is a target network. The source SGSN is a core network node of the LTE system, and a target MSC and a target SGSN is core network nodes of the GSM system. A (MGW) is an interfacing core network node between the LTE and GSM systems. An IMS SCC AS is used for handover between CS and IMS. The SRVCC handover with DTM support includes the following steps:

B1: The UE sends a measurement report to the source UTRAN.

B2: The source UTRAN decides to trigger the SRVCC handover to the target UTRAN/GERAN based on UE measurement reports.

B3: The source UTRAN sends a “Relocation Required” message to the source SGSN.

B4: The source SGSN splits the voice bearer from non-voice bearers.

B5: The source SGSN sends a PS to CS Request to MSC Server, initiating a PS-CS handover procedure for the voice bearer.

B6: The MSC server sends a SRVCC indicator to the target MSC in a Prep Handover Request, the SRVCC indicator indicating the handover is the SRVCC handover.

B7: The target MSC requests resource from the target BSS by Relocation/Handover Request.

B8: In parallel, the source SGSN requests the relocation of PS resources from the target SGSN for the non-voice bearers.

B9: The target SGSN in turn requests resources from the target BSS by Relocation/Handover Request.

B10: The target BSS sends response by a Relocation/Handover Request acknowledgement.

B11: The target BSS forwards the response to the source SGSN.

B12: The target BSS sends a Relocation/Handover Request acknowledgement back to the target MSC.

B13: The target MSC sends network call control capabilities IE in a Prep Handover CS Response message.

B14: After having received the response from the target BSS, the message are exchanged to establish traffic circuit.

B15: The MSC server initiates session transfer by sending an ISUP IAM message using session transfer number for SRVCC (STN-SR) or Emergency Session Transfer Number for SRVCC (E-STB-SR).

B16: The IMS SCC Application Server continues the handling by transferring the session, updating the remote leg.

B17: The IMS SCC Application Server releases the IMS (source) leg via E-UTRAN. From this point onwards the downlink IP (for voice) packets flow via the IMS/CS interconnecting node and are transformed to CS data streams.

B18: The MSC server sends the response for PS to CS handover to the source SGSN, including the network call control capabilities IE.

B19: The source MME forwards the network call control capabilities IE to the source E-UTRAN in a Handover command message.

B20: The source E-UTRAN forwards the network call control capabilities IE to the UE in a Handover From UTRAN command message.

B21: The UE tunes to a frequency spectrum of the target UTRAN/GERAN system.

B22: The UE performs handover detection at the target BSS.

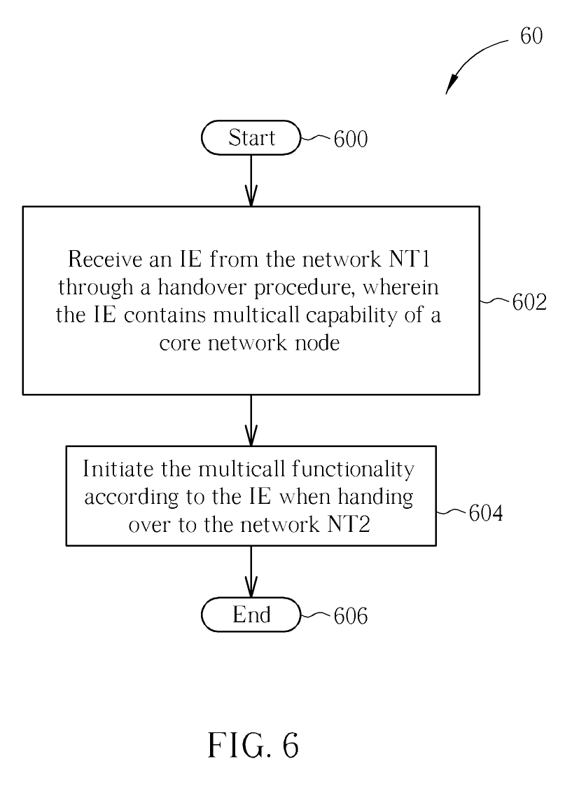

Please refer to FIG. 6, which is a flow chart of an exemplary process 60. The process 60 is used for handling multicall functionality for a UE in a wireless communication system. The wireless communication system could be the wireless communication system 10 and include a network NT1 and a network NT2. The process 60 can be compiled into the program code 214 and include the following steps:

Step 600: Start.

Step 602: Receive an IE from the network NT1 through a handover procedure, wherein the IE contains multicall capability of a core network node.

Step 604: Initiate the multicall functionality according to the IE when handing over to the network NT2.

Step 606: End.

According to process 60, the UE receives the IE from the network NT1 through the handover procedure. Preferably, the IE is a network call control multicall capability IE, which contains multicall capability of the core network node (e.g. MSC server multicall capabilities). The handover procedure is referred as to a SRVCC handover procedure. Then, the UE initiate the multicall functionality according to the IE when handing over to the network NT2. In other words, when the network NT2 forward the IE to the UE through the handover procedure, the UE receives the IE and initiates the multicall functionality according to the IE. Therefore, based on the process 60 the UE may know if the core network node supports the multicall functionality by receiving the IE. Preferably, the process 60 may cooperate with the process 30 and be used at the UE end after the process 30 is performed.

In some example, the network NT1 may be referred as to E-UTRAN. The network NT2 may be referred as to UTRAN or GREAN. In this situation, the UE may receive the IE from the E-UTRAN after the E-UTRAN forwards the network call control capabilities IE of the core network node. Then, the UE can initiate multicall if a user of the UE chooses.

In some example, the network NT1 may be referred as to a source UTRAN. The network NT2 may be referred as to a target UTRAN or GREAN. In this situation, the UE may receive the IE from the source UTRAB after the source UTRAN forwards the network call control capabilities IE of the core network node. Then, the UE can initiate multicall if a user of the UE chooses.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20 in which the processor 200 processes the program code 214 related to the abovementioned processes and the processed results can perform feedback load reduction in the wireless communications system 20.

To sum up, during the SRVCC handover Procedure, the network call control capabilities IE containing MSC server multiple capabilities of the target MSC is included in the messages involved in the SRVCC handover procedure. Therefore UE may obtain the MSC multicall capabilities of the target MSC and know if the target network supports multicall functionality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling multicall functionality for a wireless communication system, the method comprising:
sending an information element (IE) from a first core network node to a second core network node through a first message, wherein the IE contains multicall capability of the first core network node connected to a first network;
forwarding the IE from the second core network node to a second network through a second message, the second network connected to the second core network node; and
forwarding the IE from the second network to a mobile device through a handover procedure.

2. The method of claim 1, wherein the handover procedure is a single radio voice call continuity (SRVCC) handover procedure; the first core network node is a mobile switching center (MSC) server; the second core network node is a mobility management entity (MME); the first network is UMTS Terrestrial Radio Access Network (UTRAN) or GSM EDGE Radio Access Network (GREAN); the second network is Evolved UMTS Terrestrial Radio Access Network (E-UTRAN).

3. The method of claim 1, wherein the first message is a packet switch (PS) to circuit switch (CS) response message; the second message is a handover command message.

4. The method of claim 1, wherein the handover procedure is an SRVCC handover procedure; the first core network node is a MSC server; the second core network node is a Serving GPRS Support Node (SGSN); the first network is a target UTRAN or GREAN and the second network is a source UTRAN.

5. The method of claim 1, wherein the first message is a PS to CS response message; the second message is a relocation required command.

6. The method of claim 1 further comprising:
sending an indicator from a source MSC to a target MSC through a third message, wherein the indicator indicates to the target MSC that the handover procedure is a SRVCC handover procedure; and
sending the IE from the target MSC to the first core network node through a forth message according to the indicator.

7. The method of claim 6, wherein the third message is a Prep handover request message and the forth message is a Pre handover CS response message.

8. A method of handling multicall functionality for a mobile device, the method comprising:
receiving an information element (IE) in a message from a core network node after a handover procedure, wherein the IE contains multicall capability of a core network node; and
initiating the muticall functionality according to the IE after handing over from a first network to a second network.

9. The method of claim 8, wherein the handover procedure is a single radio voice call continuity (SRVCC) handover procedure, the core network node is a mobile switching center (MSC) server, the first network is Evolved UMTS Terrestrial Radio Access Network (E-UTRAN) and the second network is or UMTS Terrestrial Radio Access Network (UTRAN) or GSM EDGE Radio Access Network (GREAN).

10. The method of claim 8, wherein the handover procedure is a single radio voice call continuity (SRVCC) handover procedure, the core network node is a MSC server, the first network is a source UMTS Terrestrial Radio Access Network (UTRAN) and the second network is or a target UTRAN or GREAN.

11. A wireless communication system comprising:
a first network;
a first core network node connected to the first network, for sending an information element (IE) in a first message, wherein the IE contains multicall capability of the first core network node;
a second core network node, for receiving the IE from the first core network code and forwarding the IE in a second message; and
a second network connected to the second core network, for receiving the IE from the second core network node and forwarding the IE to a mobile device through a handover procedure.

12. The wireless communication system of claim 11, wherein the handover procedure is a single radio voice call continuity (SRVCC) handover procedure; the first core network node is a mobile switching center (MSC) server; the second core network node is a mobility management entity (MME); the first network is UMTS Terrestrial Radio Access Network (UTRAN) or GSM EDGE Radio Access Network (GREAN); the second network is Evolved UMTS Terrestrial Radio Access Network (E-UTRAN).

13. The wireless communication system of claim 11, wherein the first message is a packet switch (PS) to circuit switch (CS) response message; the second message is a handover command message.

14. The wireless communication system of claim 11, wherein the handover procedure is an SRVCC handover procedure; the first core network node is a MSC server; the second core network node is a Serving GPRS Support Node (SGSN); the first network is a target UTRAN or GREAN and the second network is a source UTRAN.

15. The wireless communication system of claim 11, wherein the first message is a PS to CS response message; the second message is a relocation required command.

16. The wireless communication system of claim 11 further comprising:
a source MSC for sending an indicator in a third message, wherein the indicator indicates to the target MSC that the handover procedure is a SRVCC handover procedure; and
a target MSC for receiving the indicator from the source MSC and sending the IE to the first core network node through a forth message according to the indicator.

17. The wireless communication system of claim 16, wherein the third message is a Prep handover request message and the forth message is a Pre handover CS response message.

18. A communication device of handling multicall functionality in a wireless communication system, the communication device comprising:
means for receiving an information element (IE) from a first network through a handover procedure, wherein the IE contains multicall capability of a core network; and
means for initiating the multicall functionality according to the IE after handing over from a first network to a second network.

19. The communication device of claim 18, wherein the handover procedure is a single radio voice call continuity (SRVCC) handover procedure, the core network node is a mobile switching center (MSC) server, the first network is Evolved UMTS Terrestrial Radio Access Network (E-UTRAN) and the second network is or UMTS Terrestrial Radio Access Network (UTRAN) or GSM EDGE Radio Access Network (GREAN).

20. The communication device of claim 18, wherein the handover procedure is a single radio voice call continuity (SRVCC) handover procedure, the core network node is a MSC server, the first network is a source UMTS Terrestrial Radio Access Network (UTRAN) and the second network is or a target UTRAN or GREAN.
